(19) United States
(12) Patent Application Publication
(10) Pub. No.: US 2017/0326997 A1
(43) Pub. Date: Nov. 16, 2017

(54) METHOD FOR RECHARGING ENERGY ACCUMULATION MEANS FITTED TO AN ELECTRIC OR HYBRID VEHICLE

(71) Applicant: LOHR ELECTROMECANIQUE, Hangenbieten (FR)

(72) Inventors: Pierre DUMAS, Strasbourg (FR); Laurent VERDIER, Eschau (FR)

(21) Appl. No.: 15/527,372

(22) PCT Filed: Nov. 17, 2015
(86) PCT No.: PCT/FR2015/053099

§ 371 Date: May 17, 2017

(30) Foreign Application Priority Data
Nov. 17, 2014 (FR) 1461089

(51) Int. Cl. B60L 11/18; B60W 30/18; B60L 7/10; B60W 20/00

(52) U.S. Cl. CPC B60L 11/1811; B60L 11/1812; B60L 11/1816; B60W 30/18127; B60L 7/10; B60L 2220/56; B60W 20/00; B60L 2220/54

(57) ABSTRACT

The invention relates to a method for recharging an electrical energy source (S) on-board an electric or hybrid vehicle, comprising at least two electric traction motors (M1,M2) respectively associated with a first and second traction converter (C1,C2) and a control electronics (E), said vehicle functioning according to a traction mode using electrical energy provided by the electrical energy source (S), according to a braking mode for recharging said electrical energy source (S) during braking or deceleration phases, and according to a shutdown recharge mode for recharging said electrical energy source (S) during the shutdown phases of the vehicle, characterized in that it consists of utilizing the control electronics (E) managing the traction converters (C1,C2) to carry out a static reconfiguration both of the two converters (C1,C2) and of the motors (M1,M2), in order to transform said converters (C1,C2) associated with the motors (M1,M2) into a charger for the on-board energy source (S).

### TECHNICAL FIELD

The present invention relates to the general technical field of electric or hybrid vehicles equipped with an on-board electric energy source.

The term on-board electric energy source is to be understood to mean traction batteries or super-capacitors or a combination of such energy sources. By definition, the present description more generally makes use of the term “battery”, thereby designating one or other of the energy sources mentioned above.

Electric or hybrid vehicles therefore include such an energy source, an electric traction machine, functioning as a motor in order to accelerate the vehicle or functioning as a generator in order to brake the vehicle. These electric or hybrid vehicles also include traction converters, made up of power electronics and control electronics. These converters manage the torque and speed of traction machines as a function of instructions that generally come from accelerator and brake pedals or from actuators or manual throttles.

The battery of such a vehicle must either be recharged dynamically by recovering the braking energy of the vehicle, or, when shutdown, by performing a full recharge knowing that dynamic recharging is generally insufficient.

The present invention relates more particularly to a recharging method for electric or hybrid vehicle batteries. The term vehicle is to be understood to mean any type of vehicle, whether individual vehicles or public transport vehicles like bus, tram or other types of public transport vehicles.

In recharging systems, using a specific converter is known for converting available energy into energy that can be directly used by an on-board battery. Such a specific converter may form part of a fixed recharging station supplied with AC voltage from the electric grid and connected to the vehicle by means of a cable and plug. Such a cabinet therefore delivers a DC voltage and a DC current, of varying amplitudes, which serves to provide effective battery charging. The amplitudes of the DC voltage and current are usually called for by on-board control electronics managing the on-board energy source namely the battery, said control electronics communicating with the charging station.

Such a specific converter can also be on-board the vehicle. The converter thus receives AC energy from a fixed installation, for example by means of a cable in order to recharge the on-board battery. In this case, the resulting charger is an active converter, which is often bulky and associated with complex control electronics. This is a non-negligible disadvantage.

From the document FR 2 938 711, a charging system is also known that uses a traction motor and its converter in order to charge the battery. In such a system, a three-phase voltage, from the fixed electrical grid, is connected to a stator winding by means of three separate entry points. The traction motor converter is thus used as a rectifier. Such a technical solution presents a number of drawbacks however.

In effect, the maximum continuous voltage that can be achieved is 540 V for a 400 V AC grid voltage. It is therefore impossible to recharge a battery with a peak to peak voltage higher than 540 V. However, on bus or tram type heavy vehicles it is common for traction batteries or super-capacitors to have a peak voltage of 750 volts.

Moreover, the traction motor winding is specific and complex, knowing that each phase is divided into two. Thus, the number of electrical connections for the traction motor is 6. In another implementation, known for example through the document FR 2,961,970, the number of electrical connections for the traction motor is 9, while the number of electrical connections for a traction motor in a standard embodiment is 3.

It should also be noted that the traction converter used in the above examples is specific and complex. This type of specific converter, in particular the one described in the document FR 2,938,711, requires the implementation of an H-bridge for each motor phase, i.e. 3 H-bridges given that the motor consists of 3 phases. Each H-bridge has 4 IGBT semiconductors. The converter thus uses 12 IGBT semiconductors, which makes it a very specific converter. By comparison, a standard converter has only 6 IGBT semiconductors.

### DISCLOSURE OF THE INVENTION

The subject of the present invention is therefore to remedy the drawbacks mentioned above and to propose a recharging method that can be implemented using simple means and/or means that already equip the vehicle.

The purposes assigned to the invention are also achieved using a method for recharging an electrical energy source on-board an electric or hybrid vehicle, comprising at least two electric traction motors respectively associated with a first traction converter and a second traction converter and a control electronics, said vehicle functioning according to a traction mode using electrical energy provided by the electrical energy source, according to a braking mode for recharging said electrical energy source during braking or deceleration phases, and according to a shutdown recharge mode for recharging said electrical energy source during the shutdown phases of said vehicle, said method consisting in utilizing the control electronics managing the traction converters to perform a reconfiguration both of the two converters and also of the motors, in order to transform said converters and said motors into a charger for the on-board energy source, characterized in that during a vehicle shutdown phase, a fixed electrical supply grid is connected to the first traction converter to provide a reference DC electrical voltage U_{R} and to reconfigure the motors:
the neutrals of the two stator windings of said motors are connected in series by means of a first switch ordered in closing position by the control electronics, which also manage other switches or commutation devices, in order to reconfigure the traction converters;
the voltage U_{B} is measured at the terminals of the on-board electric energy source;
the control electronics is used to compare the electrical voltage U_{B} to the reference electrical voltage U_{R};
if the voltage U_{B} is lower than the reference voltage U_{R}, a reconfiguration is performed consisting in transforming the first converter, supplied directly with the DC voltage U_{R}, into a buck-chopper circuit for regulating the current supplied to the on-board electric energy source, the second converter being in an inhibited state;
if the voltage U_{B} is greater than or equal to the reference voltage U_{R}, a reconfiguration is performed consisting in transforming the second converter, into a boost-chopper circuit for regulating the current supplied to the on-board electric energy source, the first converter being in an inhibited state;
the closure of the first switch is ordered; and
the opening of a second switch is ordered connecting the first traction converter to the energy source, the second traction converter remaining connected to said energy source.

According to an implementation example, the method for recharging according to the invention consists in using a reference voltage U_{R} produced by a converter rectifying a single or three-phase AC supply grid voltage.

According to an implementation example of the method according to the invention, the converter is advantageously on-board.

According to another implementation example, the method according to the invention consists in using a reference voltage U_{R} coming directly from a DC voltage supply source.

According to an application example according to the invention, the method is implemented using an electrical axle with two electric motors. The electric motors are for example in-wheel motors.

The electrical axle equips, for example, an individual vehicle or a public transport vehicle like a bus or tram.

The recharging method according to the invention has the advantage that it is implemented using the components that constitute a hybrid vehicle, including the traction motors and associated converters. It is not necessary to integrate in the vehicle a specific converter and specific and complex control electronics to proceed with the recharging.

The converters used in the device according to the invention are standard traction converters, i.e., each comprising three arms.

The only equipment added in a system implementing the present invention is, according to an embodiment example, a rectifier bridge, namely a diode bridge, which is a passive component that requires no control electronics.

A further advantage of the invention lies in the fact that each traction motor is not directly connected to the three-phase grid, each traction motor remains connected to the traction converter associated therewith.

Another remarkable advantage is obtained with the device according to the invention because it is possible to recharge batteries wherein the voltage thereof is higher than the rectified voltage of the electrical grid.

The method according to the invention additionally makes it possible to recharge a battery using all existing electrical outlets, delivering a single or three-phase AC voltage of 110 V, 230 V or 400 V, at 50 Hz or 60 Hz.

Other features and advantages of the invention will also be apparent from the drawings given by way of illustrative and non-limiting examples wherein:

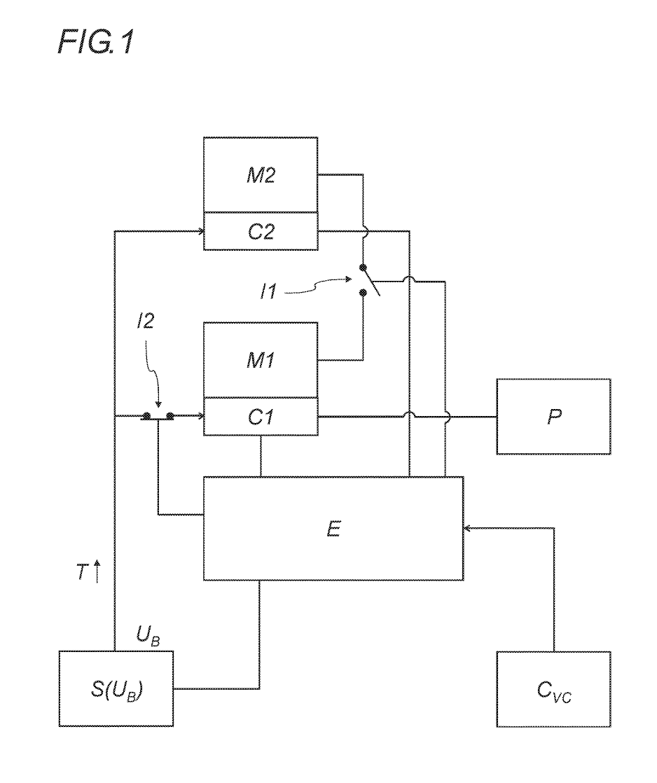

FIG. 1 is a functional diagram illustrating the method for recharging according to the invention, when the electric or hybrid vehicle is in an operating mode corresponding to a traction mode;

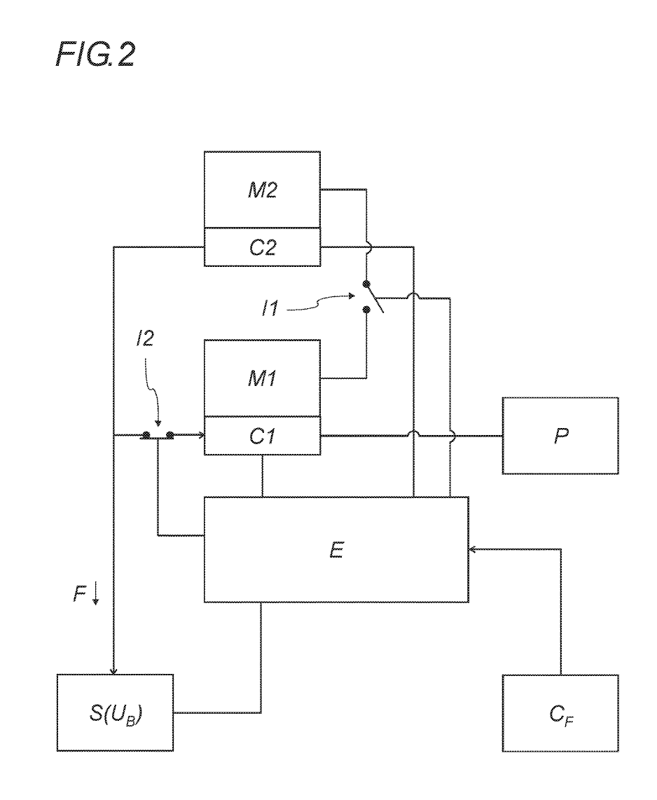

FIG. 2 shows a functional diagram illustrating the method for recharging according to the invention, when the electric or hybrid vehicle is in an operating mode corresponding to a braking mode, and

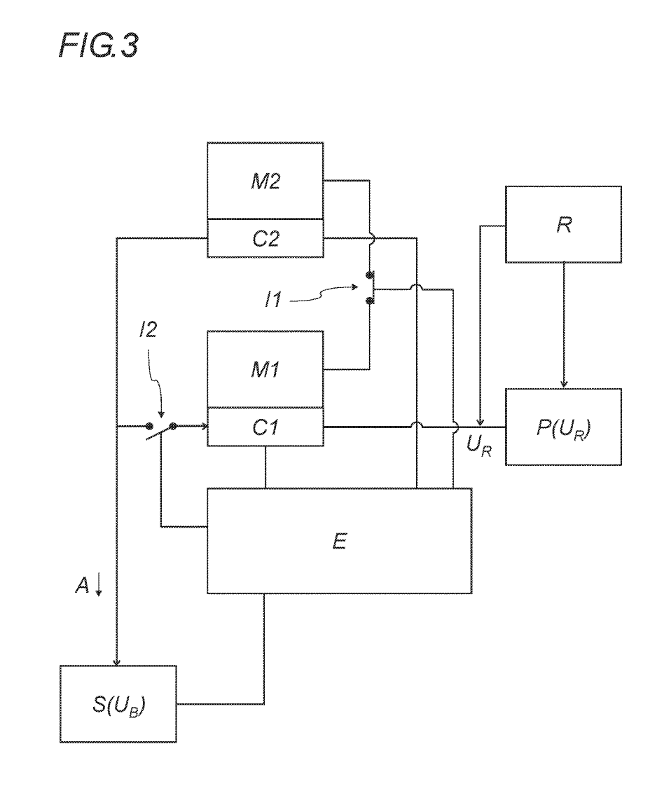

FIG. 3 shows a functional diagram illustrating the method for recharging according to the invention, when the electric or hybrid vehicle is in shutdown recharge mode.

### DETAILED DESCRIPTION OF THE FIGURES

FIG. 1 illustrates the method for recharging according to the invention when the vehicle is in traction mode, i.e., when control electronics E receives a torque and/or speed instruction C_{vc}.

The motorization consists of a first motor M1 and a second motor M2, for example electric motors of the in-wheel motor type; each motor is associated with a respective traction converter C1 and C2, which are also called inverters.

A torque or speed instruction C_{vc} is then transmitted by any known means to the control electronics E. This latter is interconnected to the traction converters C1 and C2 as well as to the on-board electric energy source S.

A converter rectifying the electrical voltage or rectifier bridge P, for example on-board, is connected to the first traction converter C1. Such a converter or rectifier bridge P makes it possible to rectify a voltage from a single or three-phase AC electrical supply grid. The rectifier bridge P only intervenes during the recharging phase when the vehicle is shutdown.

According to another implementation example, it is possible to use a reference electric voltage U_{R} coming directly from a DC voltage supply source, thus avoiding the use of an on-board rectifier bridge.

The control electronics E makes it possible to maintain the stator windings of the traction motors M1 and M2 in a disconnected state. Such a disconnection state is obtained by means of switching devices indicated schematically by a first switch I1 that is managed by the control electronics E. The first switch I1 is held open in this traction mode.

In shutdown recharge mode, each converter C1, C2 is advantageously constituted of three arms used in interlaced manner in order to reduce the phase current, thus reducing the current ripple.

The windings of the electric motors M1, M2 are implemented such that the neutrals can be accessible for connection thereof.

In traction operating mode, the traction motors M1 and M2 are supplied with electrical energy from the source S. These supplies, indicated schematically by the arrow T, are provided by means of the traction converters C1 and C2. A switching devices, indicated schematically by the second switch I2, commanded to closed position via control electronics E, makes it possible to connect the first converter C1 to the on-board energy source S. The flow of power transmitted in this operating mode is therefore indicated schematically by the arrow T.

Such a power supply is known as such, and will not be described in more detail.

FIG. 2 illustrates the method according to the invention in a recharging phase, and more specifically when the electric or hybrid vehicle is in an operating phase corresponding to braking or deceleration.

In such an operating mode the traction motors M1 and M2 are transformed into current generators that supply the energy source S through the converters C1 and C2.

This operating mode, called braking mode, known as such and managed by the control electronics E, is of course initiated by a braking or deceleration instruction Cf. The recharging of the energy source S is indicated schematically using the arrow F in FIG. 2. The switches I1 and I2 remain respectively in open and closed position in this braking mode.

In traction mode, as in braking mode, the converters C1 and C2 are connected in parallel to the on-board energy source S.

FIG. 3 illustrates an operating phase corresponding to a shutdown recharging of the vehicle. This shutdown recharge mode corresponds to the connection of the rectifier bridge P to an electrical supply of the electric grid, providing an AC voltage U_{R}. The control electronics E then makes it possible to reconfigure the traction motors M1 and M2 by connecting their stator windings in series and more precisely the neutrals of said motors M1, M2. This connection is obtained by means of switching devices indicated schematically by the first switch I1, which is ordered into closed position. At the same time, the second switch I2 is ordered into open position by the control electronics E.

In this shutdown recharge mode, the control electronics E make it possible to reconfigure the traction converters C1 and C2. The electronic components used in the control electronics E in order to implement such a reconfiguration are known as such.

The reconfiguration therefore consists first in measuring the electric voltage U_{B} at the terminals of the on-board electric energy supply and in using the control electronics E to compare said voltage U_{B} to the rectified electrical voltage U_{R} of the fixed supply grid.

The method according to the invention then consists in adapting the static reconfiguration of the converters C1 and C2, depending upon the result of the comparison between the electrical voltage U_{B} and the electrical voltage U_{R}.

If the electric voltage U_{B} is lower than the electric voltage U_{R}, the reconfiguration consists in transforming the first converter C1 into a buck-chopper circuit for regulating the current delivered to the on-board energy source S. The latter is then recharged by means of the reconfigured second converter C2, as is indicated schematically by the arrow A in FIG. 3. The second converter C2 is then inhibited by forcing open the IGBT semiconductors of said second converter C2.

Conversely, if the electric voltage U_{B} is greater than or equal to the electric voltage U_{R}, the reconfiguration consists in transforming the second converter C2, into a boost-chopper circuit for regulating the current delivered to the on-board electric energy source S. The latter is then recharged via the reconfigured second converter C2, as is indicated schematically by the arrow A in FIG. 3. The first converter C1 is then inhibited. The IGBT semiconductors of the first converter C1 are driven open thus rendering it transparent.

In one or other of the reconfigurations of the converters C1 and C2, the stator windings of the motors M1 and M2 remain connected in series by the neutrals thereof. The switches I1 and I2 therefore remain ordered respectively into closed and open position during the shutdown recharging mode. During these two reconfigurations, the on-board energy source S, the converters C1 and C2, and the rectifier bridge P remain connected in cascade.

The recharging method according to the invention finds application thereof particularly in a vehicle of bus or tram type or in an individual vehicle, having at least one electrical axle. The latter has for example two independent in-wheel motors. The corresponding wheels can be mechanically linked or not.

According to another example according to the invention, the method is implemented with two independent electric motors arranged outside the wheels.

For example, the electric voltage provided by the fixed grid U_{R} is single phase 230 V at 50 Hz or three-phase 400 V at 50 Hz. Thus, the rectified AC voltage of 400 V corresponds to the DC voltage U_{R} of 540 V.

During the transition from one reconfiguration to another, especially during the transition from the buck-chopper circuit to a boost-chopper circuit, i.e., during the disabling of the buck-chopper circuit and the activation of the boost-chopper circuit, a hybrid operation can be initiated. During this transition, the buck and boost chopper circuits operate simultaneously, thereby obtaining a smooth transition. The buck-chopper circuit will gradually ramp down in favor of the boost-chopper circuit.

It is obvious that this description is not limited to the examples explicitly described, but that it also includes other embodiments and/or implementations. Thus, a described technical feature can be replaced by an equivalent technical feature, without departing from the scope of the present invention. In the same way, a described step can be replaced by an equivalent step, without departing from the scope of the present invention.

1. Method for recharging an electrical energy source (S) on-board an electric or hybrid vehicle, comprising at least two electric traction motors (M1,M2) respectively associated with a first traction converter (C1) and a second traction converter (C2) and a control electronics (E), said vehicle functioning according to a traction mode (T) using electrical energy provided by the electrical energy source (S), according to a braking mode for recharging said electrical energy source (S) during braking or deceleration phases, and according to a shutdown recharge mode for recharging said electrical energy source (S) during the shutdown phases of said vehicle, said method consisting in utilizing the control electronics (E) managing the traction converters (C1,C2) to perform a reconfiguration both of the two converters (C1,C2) and also of the motors (M1,M2), in order to transform said converters (C1,C2) and said motors (M1,M2) into a charger for the on-board energy source (S), characterized in that during a vehicle shutdown phase, a fixed electrical supply grid (R) is connected to the first traction converter (C1) to provide a reference DC electrical voltage U_{R} and to reconfigure the motors (M1, M2):
the neutrals of the two stator windings of said motors (M1, M2) are connected in series by means of a first switch (I1) ordered in closing position by the control electronics (E), which also manage other switches or commutation devices, in order to reconfigure the traction converters (C1, C2);
the voltage U_{B} is measured at the terminals of the on-board electric energy source (S);
the control electronics (E) is used to compare the electrical voltage U_{B} to the reference electrical voltage U_{R};
if the voltage U_{B} is lower than the reference voltage U_{R}, a reconfiguration is performed consisting in transforming the first converter (C1), supplied directly with the reference voltage U_{R}, into a buck-chopper circuit for regulating the current supplied to the on-board electric energy source (S), the second converter (C2) being in an inhibited state;
if the voltage U_{B} is greater than or equal to the reference voltage U_{R}, a reconfiguration is performed consisting in transforming the second converter (C2), into a boost-chopper circuit for regulating the current supplied to the on-board electric energy source (S), the first converter (C1) being in an inhibited state;
the closure of the first switch (I1) is ordered; and
the opening of a second switch (I2) is ordered connecting the first traction converter (C1) to the energy source (S), the second traction converter (C2) remaining connected to said energy source (S).

2. Method for recharging according to claim 1, characterized in that it consists in using a reference voltage U_{R} produced by a converter (P) rectifying a single or three-phase AC supply grid voltage.

3. Method for recharging according to claim 2, characterized in that the converter (P) is on-board.

4. Method for recharging according to claim 1, characterized in that it consists in using a reference voltage U_{R} coming directly from a DC voltage supply source.

5. Use of an electrical axle comprising two electric motors (M1, M2) in order to implement the method according to claim 1.

6. Use according to claim 5, characterized in that the electric motors (M1, M2) are in-wheel motors.

7. Use according to claim 5, characterized in that the electrical axle equips an individual vehicle.

8. Use according to claim 5, characterized in that the electrical axle equips a public transport vehicle like a bus or tram.
